(19) United States
(12) Patent Application Publication
(10) Pub. No.: US 2024/0320891 A1
(43) Pub. Date: Sep. 26, 2024

(54) SOCIAL INTERACTION METHOD AND APPARATUS, DEVICE, READABLE STORAGE MEDIUM, AND PROGRAM PRODUCT

(71) Applicant: Tencent Technology (Shenzhen) Company Limited, Shenzhen (CN)

(72) Inventor: Teng Chen, Shenzhen (CN)

(21) Appl. No.: 18/679,286

(22) Filed: May 30, 2024

Related U.S. Application Data
(63) Continuation of application No. PCT/CN2023/099810, filed on Jun. 13, 2023.

(30) Foreign Application Priority Data
Aug. 5, 2022 (CN) 202210939896.4

(51) Int. Cl. G06T 13/20; G06F 3/04815; G06F 3/0484; G06Q 50/00; G06T 13/40; G10L 17/02

(52) U.S. Cl. CPC G06T 13/205; G06Q 50/01; G06T 13/40; G06F 3/04815; G06F 3/0484; G06T 2200/24; G10L 17/02

(57) ABSTRACT

This application relates to the field of interface interactions, and in particular, to a social networking method performed by a computer device. The method includes: displaying a scene picture corresponding to a first display range of a virtual social scene, the virtual social scene including a first virtual object and a second virtual object, the second virtual object being located within a first region in the virtual social scene; receiving a first display range adjustment operation for adjusting a display range of the virtual social scene from the first display range to a second display range; when the second display range and the first ground region range satisfy a positional relationship requirement, displaying an animation of the first virtual object moving into the first region; and displaying a social networking animation of the first virtual object and the second virtual object within the first region.

### CROSS-REFERENCE TO RELATED APPLICATIONS

This application is a continuation application of PCT Patent Application No. PCT/CN2023/099810, entitled “SOCIAL INTERACTION METHOD AND APPARATUS, DEVICE, READABLE STORAGE MEDIUM, AND PROGRAM PRODUCT” filed on Jun. 13, 2023, which claims priority to Chinese Patent Application No. 202210939896.4, “SOCIAL INTERACTION METHOD AND APPARATUS, DEVICE, READABLE STORAGE MEDIUM, AND PROGRAM PRODUCT” filed on Aug. 5, 2022, both of which are incorporated herein by reference in their entirety.

### FIELD OF THE TECHNOLOGY

This application relates to the field of interface interaction, and in particular, to a social networking method and apparatus, a device, a readable storage medium, and a program product.

### BACKGROUND OF THE DISCLOSURE

In an application based on a virtual social scene, a multi-person voice chat refers to a social form in which a plurality of virtual objects in the virtual social scene implement a voice conversation through devices such as a microphone and a speaker.

In the related art, when a distance among the plurality of virtual objects in the virtual social scene is less than a distance threshold, a multi-person voice chat among the plurality of virtual objects is enabled. When a primarily controlled virtual object approaches another virtual object, a user needs to control a movement direction and a motion form of the primarily controlled virtual object in the virtual social scene in real time, such as walking to the left and running to the right.

However, through the foregoing manner of enabling the multi-person voice chat, the user needs to control, through a real-time control operation, the primarily controlled virtual object to move in the virtual social scene and move from a starting point of movement gradually into a distance threshold corresponding to another virtual object. This process is cumbersome, resulting in lower efficiency of enabling the multi-person voice chat.

### SUMMARY

Embodiments of this application provide a social networking method and apparatus, a device, a readable storage medium, and a program product, which can improve efficiency of a social networking performed by a primarily controlled virtual object in a virtual social scene. The technical solutions are as follows.

According to an aspect, a social networking method is performed by a computer device, the method including:
displaying a scene picture corresponding to a first display range of a virtual social scene, the virtual social scene including a first virtual object and a second virtual object, the second virtual object being located within a first region in the virtual social scene;
receiving a first display range adjustment operation for adjusting a display range of the virtual social scene from the first display range to a second display range;
when the second display range and the first ground region range satisfy a positional relationship requirement, displaying an animation of the first virtual object moving into the first region; and
displaying a social networking animation of the first virtual object and the second virtual object within the first region.

According to another aspect, a computer device is provided, including a processor and a memory, the memory having at least one instruction, at least one program, a code set, or an instruction set stored therein, the at least one instruction, the at least one program, the code set, or the instruction set being loaded and executed by the processor and causing the computer device to implement the social networking method according to any one of the foregoing embodiments of this application.

According to another aspect, a non-transitory computer-readable storage medium is provided, having at least one instruction, at least one program, a code set, or an instruction set stored therein, the at least one instruction, the at least one program, the code set, or the instruction set being loaded and executed by a processor of a computer device and causing the computer device to implement the social networking method according to any one of the foregoing embodiments of this application.

The technical solutions provided in the embodiments of this application include at least the following beneficial effects.

Through a manner in which a target social location is determined by changing a range of the virtual social scene displayed in a terminal screen, so that the virtual object appears at the target social location and interacts with another virtual object, the virtual object does not need to be gradually controlled to move from a starting point to the target social location, which simplifies the process of enabling a virtual interaction. Compared with the method required to control a movement direction and a mode of motion of the virtual object strictly based on a movement path in the related art, the method provided in the embodiments of this application has simple operation and no cumbersome operations, which improves efficiency of controlling the virtual object to perform a social networking in the virtual social scene by a user.

### BRIEF DESCRIPTION OF THE DRAWINGS

FIG. 1 is a schematic diagram showing an interaction of virtual objects according to an exemplary embodiment of this application.

FIG. 2 is a structural block diagram of an electronic device according to an exemplary embodiment of this application.

FIG. 3 is a structural block diagram of a computer system according to an exemplary embodiment of this application.

FIG. 4 is a flowchart of a social networking method according to an exemplary embodiment of this application.

FIG. 5 is a schematic diagram of a social networking method according to an exemplary embodiment of this application.

FIG. 6 is a schematic diagram displaying a social networking animation according to an exemplary embodiment of this application.

FIG. 7 is a flowchart showing that a first virtual object exits a current social networking according to an exemplary embodiment of this application.

FIG. 8 is a schematic diagram showing that a first virtual object leaves a first ground region range and is moved to a center of a second ground region range according to an exemplary embodiment of this application.

FIG. 9 is a flowchart showing that a third virtual object joins a social networking with a first virtual object and is rejected by the first virtual object according to another exemplary embodiment of this application.

FIG. 10 is a schematic diagram of a social networking animation of a first virtual object and a third virtual object within a second ground region range according to another exemplary embodiment of this application.

FIG. 11 is a schematic diagram of a permission of a first virtual object after clicking/tapping an avatar of a third virtual object according to another exemplary embodiment of this application.

FIG. 12 is a schematic diagram of a permission of a third virtual object after clicking/tapping an avatar of a first virtual object according to another exemplary embodiment of this application.

FIG. 13 is a schematic diagram showing that a first virtual object kicks a third virtual object out of a current social networking according to another exemplary embodiment of this application.

FIG. 14 is an operation flowchart showing that a first virtual object is used as a primarily controlled terminal device according to another exemplary embodiment of this application.

FIG. 15 is a timing diagram among a user layer, a client presentation layer, and a background logic layer according to another exemplary embodiment of this application.

FIG. 16 is a structural block diagram of a social networking apparatus according to an exemplary embodiment of this application.

FIG. 17 is a structural block diagram of a social networking apparatus according to another exemplary embodiment of this application.

FIG. 18 is a structural block diagram of a computer device according to an exemplary embodiment of this application.

### DESCRIPTION OF EMBODIMENTS

In a social application or some applications based on a virtual social scene, a user usually can control a virtual object to perform various actions in a virtual scene, or the user can control the virtual object to interact with another virtual object in the virtual scene.

The user may control a primarily controlled virtual object to move in the virtual social scene, so as to shorten a distance between the primarily controlled virtual object and another virtual object. When the distance between the virtual objects is less than a preset distance threshold, a social networking between the primarily controlled virtual object and the another virtual object may be enabled.

Exemplarily, the user controls a current virtual object to move in any direction to search for a target virtual object to enable a social networking. When the distance between the current virtual object and the target virtual object is less than the preset threshold, the social networking is enabled. During the movement of the current virtual object, a movement process and a movement picture of the current virtual object in the virtual social scene are displayed on an interface of a terminal device in real time.

However, in the related art, to implement a process of moving the virtual object from a starting point to an end point, a movement direction and a mode of motion of the virtual object need to be gradually controlled. The operation is relatively cumbersome, and a movement speed of the virtual object is also limited, which causes low efficiency of the social networking between the virtual objects.

However, in the embodiments of this application, the social networking between the virtual objects may be implemented by sliding a screen of the terminal device. The user slides the screen to perform an adjustment operation on a display range of the current virtual object. An adjustment operation performed on the display range is implemented based on the virtual social scene. During the adjustment of the display range, the virtual social scene observed by the user through the screen is also constantly changing. The user adjusts the display range until a target location is found. The current virtual object immediately appears at the target location after releasing the screen for a specific preset duration. If another virtual object has already existed at the target location, a device permission for a social networking is automatically turned on, and the current virtual object joins the social networking. If no other virtual object exists at the target location, the device permission for the social networking is not turned on, and the current virtual object does not join the social networking.

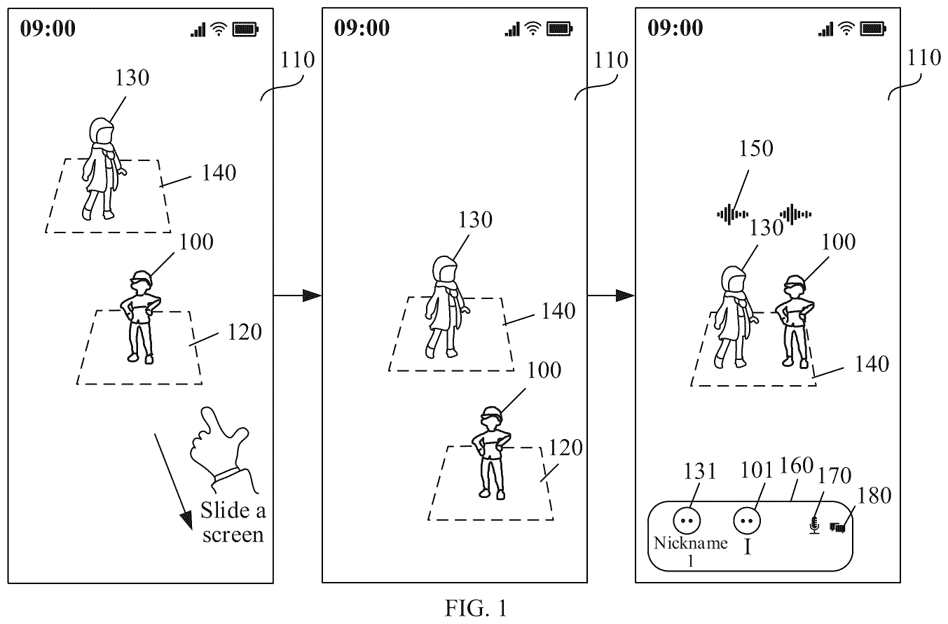

Exemplarily, as shown in FIG. 1, when a primarily controlled virtual object 100 is located in the middle of a virtual social scene 110, i.e., a first position 120, another virtual object 130 also exists in a current virtual social scene 110. The another virtual object 130 is located in a second position 140 in the virtual social scene 110. In response to an operation of adjusting a display range of the primarily controlled virtual object 100, the second position 140 in which the another virtual object 130 is located is caused to overlap with the display range of the primarily controlled virtual object 100. The display range is a middle region of a screen. The primarily controlled virtual object 100 that is moved to the second position 140 is displayed, and a social networking animation of the primarily controlled virtual object 100 and the another virtual object 130 in the second position 140 is displayed.

In response to the operation of the social networking between the primarily controlled virtual object 100 and the another virtual object 130, voice acquisition components such as microphones and speakers of the primarily controlled virtual object 100 and the another virtual object 130 are automatically enabled.

Specifically, a volume identifier 150 is displayed above each of the primarily controlled virtual object 100 and the another virtual object 130, and a prompt box 160 is displayed below the screen. The prompt box includes the following identifiers: an avatar 101 of the primarily controlled virtual object 100, an avatar 131 of the another virtual object 130, a microphone 170, and a text bubble 180.

The volume identifier 150 and the prompt box 160 indicate that a social networking is being performed between the primarily controlled virtual object 100 and the another virtual object 130. A voice interaction may be enabled or disabled in response to an operation of clicking/tapping the microphone 170. A text interaction may be enabled or disabled in response to an operation of clicking/tapping the text bubble 180.

The terminal in this application may be a desktop computer, a laptop computer, a mobile phone, a tablet computer, an e-book reader, a moving picture experts group audio layer III (MP3) player, a moving picture experts group audio layer IV (MP4) player, and the like. An application that supports the virtual scene, such as an application that supports a three-dimensional virtual scene, is installed and run in the terminal.

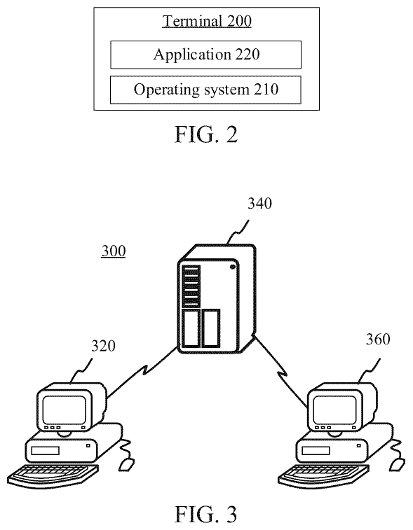

FIG. 2 is a structural block diagram of an electronic device according to an exemplary embodiment of this application. An electronic device 200 includes an operating system 210 and an application 220.

The operating system 210 is basic software that provides secure access to computer hardware for the application 220.

The application 220 is an application that supports a virtual scene. In some embodiments, the application 220 is an application that supports a three-dimensional virtual scene.

FIG. 3 is a structural block diagram of a computer system according to an exemplary embodiment of this application. A computer system 300 includes a first device 320, a server 340, and a second device 360.

An application that supports a virtual scene is installed and run in the first device 320. The first device 320 is a device used by a first user. The first user uses the first device 320 to control a first virtual object located in the virtual scene to perform an activity. The activity includes but is not limited to at least one of adjusting a display range, moving a position, and performing a social networking. Exemplarily, the first virtual object is a first virtual character, for example, a simulated character or a cartoon character.

The first device 320 is connected to the server 340 through a wireless network or a wired network.

The server 340 includes at least one of one server, a plurality of servers, a cloud computing platform, and a virtualization center. The server 340 is configured to provide a background service for an application that supports a three-dimensional virtual scene. In some embodiments, the server 340 is in charge of primary computing, and the first device 320 and the second device 360 are in charge of secondary computing. Alternatively, the server 340 is in charge of secondary computing, and the first device 320 and the second device 360 are in charge of primary computing. Alternatively, the server 340, the first device 320, and the second device 360 perform collaborative computing by using a distributed computing architecture.

An application that supports a virtual scene is installed and run in the second device 360. The second device 360 is a device used by a second user. The second user uses the second device 360 to control a second virtual object located in the virtual scene to perform an activity. The activity includes but is not limited to at least one of adjusting a display range, moving a position, and performing a social networking. Exemplarily, the second virtual object is a second virtual character, for example, a simulated character or a cartoon character.

In some embodiments, the first virtual object and the second virtual object are in the same virtual scene. In some embodiments, the first virtual object and the second virtual object may belong to the same team, the same organization, have a friend relationship, or have temporary communication permissions. In some embodiments, the first virtual object and the second virtual object may also belong to different teams, different organizations, or two hostile groups.

In some embodiments, the application installed on the first device 320 is the same as the application installed on the second device 360, or the applications installed on the two devices are the same type of application on different control system platforms. The first device 320 may refer to one of a plurality of devices, and the second device 360 may refer to one of a plurality of devices. Only the first device 320 and the second device 360 are used as an example for description in this embodiment. The first device 320 and the second device 360 are of the same device type or different device types. The device type includes at least one of a game console, a desktop computer, a smartphone, a tablet computer, an e-book reader, an MP3 player, an MP4 player, and a laptop computer. The following embodiments are described by using an example in which the device is the smartphone.

A person skilled in the art may understand that more or fewer devices may be provided. For example, only one device, or dozens or hundreds of devices, or a larger quantity of devices may be provided. A quantity of the devices and the device type are not limited in the embodiments of this application.

The foregoing server 340 may be implemented as a physical server, or may be implemented as a cloud server in the cloud. In some embodiments, the foregoing server 340 may further be implemented as a node in a blockchain system.

In some embodiments, the method provided in this embodiment of this application may be applied to a cloud social scene, so as to complete calculation of data logic in a social process through the cloud server, and a terminal is responsible for display of a social interface.

Information (including but not limited to user device information, user personal information, and the like), data (including but not limited to data for analysis, stored data, displayed data, and the like), and signals involved in this application are all authorized by users or fully authorized by all parties, and collection, use, and processing of relevant data need to comply with relevant laws, regulations, and standards of relevant countries and regions. For example, social data involved in this application is obtained with full authorization.

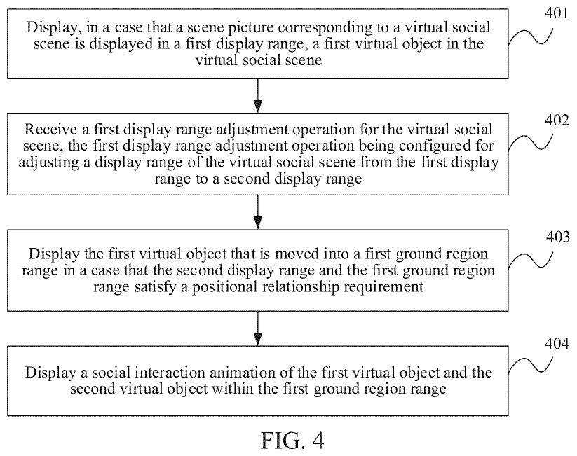

The social networking method provided in the embodiments of this application is described in combination with an introduction to the foregoing terms and the description of an implementation environment. FIG. 4 is a flowchart showing a social networking method according to an exemplary embodiment of this application. A description is given by using an example in which the method is applied to a terminal. As shown in FIG. 4, the method includes the following operations.

Operation 401: Display, when a scene picture corresponding to a virtual social scene is displayed in a first display range, a first virtual object in the virtual social scene.

The first virtual object is a virtual object primarily controlled by a current terminal.

In some embodiments, in the virtual social scene, the current terminal may control a plurality of virtual objects. Control priorities respectively corresponding to the plurality of virtual objects may be the same or different.

In some embodiments, when the control priorities respectively corresponding to the plurality of virtual objects are different, the virtual object primarily controlled by the current terminal and a virtual object secondarily controlled by the current terminal exist in the plurality of virtual objects. For the current terminal, the control priority corresponding to the primarily controlled virtual object is higher than the control priority corresponding to the secondarily controlled virtual object.

Exemplarily, the current terminal may simultaneously control a virtual character and a virtual pet in a game. The virtual object primarily controlled by the terminal is the virtual character, and the secondarily controlled virtual object is the virtual pet. Then when the terminal controls the virtual character to move forward, the virtual pet may follow the virtual character to move.

In some embodiments, the virtual object primarily controlled by the current terminal may also be controlled by another terminal. The plurality of terminals that have permissions to control the virtual object primarily controlled by the current terminal correspond to different terminal priorities.

Exemplarily, both a terminal 1 and a terminal 2 have control permissions for a virtual object a. For the virtual object a, a terminal priority of the terminal 1 is higher than a terminal priority of the terminal 2. Then the virtual object a receives both a moving instruction transmitted by the terminal 1 and a jumping instruction transmitted by the terminal 2, and the virtual object a is moved instead of jumping.

The foregoing first display range refers to a range of the virtual social scene displayed on a current terminal screen. For example, the virtual social scene includes a scene 1 and a scene 2. Since a display range of a terminal screen is limited, all scenes in the virtual social scene cannot be displayed. In an initial state, the scene 1 is displayed on the terminal screen. When a player performs a sliding operation on the terminal screen, the virtual social scene displayed on the terminal screen is adjusted from the scene 1 to the scene 2.

In some embodiments, a scene picture corresponding to the virtual social scene displayed in the first display range is a scene picture corresponding to a virtual social scene from a social object perspective of a first social account. The social object perspective may be implemented as a first-person perspective, or the social object perspective may be implemented as a third-person perspective.

In some embodiments, the foregoing first display range is a range of a virtual social scene displayed on a first screen region of the current terminal screen. The first screen region is a partial screen region of the current terminal screen. In some embodiments, the current terminal screen includes a plurality of screen regions. Different scene pictures of the virtual social scene are displayed in different screen regions.

Exemplarily, it is assumed that the terminal screen includes the first screen region and a second screen region. A first scene picture corresponding to the virtual social scene may be displayed in the first screen region by using the first display range, and a second scene picture corresponding to the virtual social scene may be displayed in the second screen region by using the second display range.

In some embodiments, picture scaling ratios corresponding to the first scene picture and the second scene picture may be the same or different. Exemplarily, the first scene picture is a virtual social scene displayed at 1:1 (i.e., the first scene picture includes less picture content), and the second scene picture is a virtual social scene displayed at 1:2 (i.e., the second scene picture includes more picture content).

In some embodiments, an overlap relationship (including a full overlap and a partial overlap) may exist between the first scene picture and the second scene picture, or no overlap relationship exists between the first scene picture and the second scene picture.

In some embodiments, the social object perspectives corresponding to the first scene picture and the second scene picture may be the same or different. For example, the first scene picture is the scene 1 from the first-person perspective, and the second scene picture is the scene 1 from the second-person perspective.

In some embodiments, the first virtual object includes some preset object information, such as an identifier name of the first virtual object, a virtual image of the first virtual object displayed in a current virtual social scene, an account number corresponding to the first virtual object, and status information of a current social networking of the first virtual object. When the first virtual object in the virtual social scene is displayed, part or all of the object information of the first virtual object is displayed.

The virtual social scene further includes a second virtual object. The second virtual object is another virtual object other than the first virtual object. The second virtual object is located in a first ground region range divided in the virtual social scene. The first ground region range is a ground range in the virtual social scene that is not currently in a specified position in the first display range. The first ground region range is a ground range in the virtual social scene that is not currently in a center of the first display range.

In some embodiments, one second virtual object or a plurality of second virtual objects may be provided.

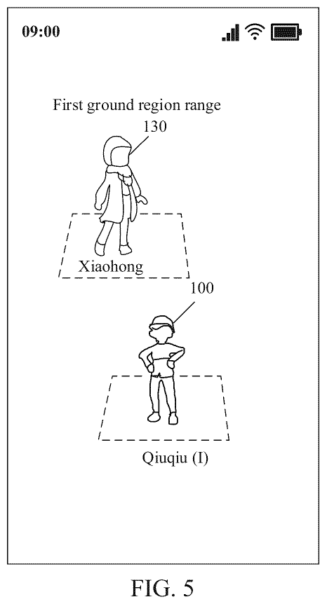

Exemplarily, FIG. 5 is a schematic diagram of a social networking method according to an exemplary embodiment of this application. A first virtual object 100 with an identifier name of “Qiuqiu” is used as an example. A virtual social scene is an open space. A first display range of the first virtual object 100 is a corresponding range in the virtual social scene of a picture in a virtual social scene displayed on a terminal screen. A first ground region range of a second virtual object 130 with an identifier name of “Xiaohong” in the virtual social scene is specifically displayed as projecting a three-dimensional virtual social scene onto a two-dimensional plane by using the ground as a reference. In the plan view, the second virtual object 130 is located at the upper left of the first virtual object 100.

The foregoing first ground region range may be any ground range in the virtual social scene. The identifier names of all virtual objects may be composed of any characters, such as Chinese characters, English characters, and numeric characters. The second virtual object may be located in any orientation of the first virtual object. The virtual social scene may be displayed as a scene of any theme, and a quantity of the virtual objects present in the virtual social scene may be arbitrary. A mobile terminal that performs a social networking of the virtual objects may be a device such as a mobile phone, a laptop computer, or a tablet computer, which is not limited in this embodiment.

Operation 402: Receive a first display range adjustment operation for the virtual social scene, the first display range adjustment operation being configured for adjusting a display range of the virtual social scene from the first display range to a second display range.

The first display range adjustment operation refers to an operation of sliding a screen of a terminal device by a user, so that a display range displayed on a screen of the mobile terminal changes and is adjusted from the first display range to another display range, i.e., the second display range.

In some embodiments, the operation of sliding the screen of the terminal device by the user includes but is not limited to the following.
1. Sliding by touching: touching and sliding the screen through a finger.
2. Sliding through a mouse: selecting and sliding the screen through the mouse.
3. Sliding through gravity induction: sliding the screen by tilting the terminal device toward a left-right orientation or a front-back orientation.
4. Control sliding through voice/gestures: the user controls the screen to slide through a voice instruction or a gesture instruction.

The operation of sliding the screen described above is adaptively selected based on the type of the terminal device, which is not limited in this embodiment.

In some embodiments, the first display range and the second display range are two display ranges that do not intersect each other, or the first display range and the second display range are two display ranges that partially intersect, which is not limited in this embodiment.

The mobile terminal device may be any device or accessory that can adjust the display range, which is not limited in this embodiment.

Operation 403: Display the first virtual object that is moved into a first ground region range when the second display range and the first ground region range satisfy a positional relationship requirement.

In some embodiments, that the second display range and the first ground region range satisfy the positional relationship requirement means that an overlap relationship exists between a first identification point in the second display range and the first ground region range. The first identification point is configured to indicate a first position in the second display range. A specific determination manner includes at least one of the following manners:
1. The first identification point in the second display range is mapped to the virtual social scene to obtain a first mapping position. If the first mapping position is located within the first ground region range, it indicates that an overlap relationship exists between the first identification point in the second display range and the first ground region range, namely, the second display range and the first ground region range satisfy a positional relationship requirement.
2. The first ground region range is mapped to a two-dimensional plane of the second display range to obtain a second mapping region. If the second mapping region includes the first identification point within the second display range, it indicates that an overlap relationship exists between the first identification point in the second display range and the first ground region range, namely, the second display range and the first ground region range satisfy the positional relationship requirement.

Exemplarily, a central point of the second display range is selected as the first identification point in the second display range. If an overlap relationship exists between the central point and the first ground region range, it indicates that the second display range and the first ground region range satisfy the positional relationship requirement.

The foregoing mapping process is to cause the first ground region range in the three-dimensional virtual social scene to correspond to the two-dimensional display range displayed on the screen of the mobile terminal device. The first identification point in the second display range may be an identification point of any position, which is not displayed on the screen of the terminal device and is completed by the background.

After it is determined that the second display range and the first ground region range satisfy the positional relationship requirement, it continues to be determined whether a duration after release has reached a preset duration. After the preset duration is reached, the first virtual object that is moved into the first ground region range is displayed.

Exemplarily, after the display range of the virtual social scene is adjusted by sliding the screen of the mobile terminal device until the adjusted display range of the virtual social scene overlaps the display range of the first ground region, the duration after release exceeds 2 seconds. If the operation of adjusting the display range is not continued within the 2 seconds, the first virtual object that is moved into the first ground region range is displayed.

The duration after release is a preset duration, which may be any duration and is not limited in this embodiment.

In some embodiments, in addition to the foregoing method for automatically displaying the first virtual object to the first ground region range, the user may also trigger the display of the first virtual object to the first ground region range to enable a social networking with the second virtual object.

In some embodiments, when the second display range and the first ground region range satisfy the positional relationship requirement, a selection operation performed on the second virtual object within the first ground region range is received. The first virtual object that is moved into the first ground region range is displayed in response to the selection operation.

Exemplarily, after the user slides the screen to switch the display range, if the switched display range and the first ground region range satisfy the positional relationship requirement, for example, if the switched display range includes the first ground region range, it represents that the user may interact with the second virtual object in the first ground region range. Then after the user clicks/taps the second virtual object, the first virtual object representing the user is displayed in the first ground region range, thereby enabling the interaction with the second virtual object.

Then when the second display range and the plurality of ground region ranges satisfy the positional relationship requirement (for example, the second display range includes the plurality of ground region ranges), the user may select virtual objects displayed within the plurality of ground region ranges, and the user decides which virtual object to interact with. According to the method provided in the embodiments of this application, the user may choose an object to interact with as needed while improving efficiency of controlling the virtual object to perform the social networking in the virtual social scene by the user, which improves freedom and flexibility of the social networking.

Operation 404: Display a social networking animation of the first virtual object and the second virtual object within the first ground region range.

In some embodiments, after the first virtual object is added to the first ground region range, a voice acquisition component of each of the first virtual object and the second virtual object within the first ground region range is automatically enabled. The voice acquisition component includes a microphone and a speaker. The first virtual object and the second virtual object may automatically join a social voice interaction through the voice acquisition component.

After the first virtual object and the second virtual object join the social voice interaction, when at least one of the first virtual object and the second virtual object transmits a session audio, a voice identification element is displayed at a preset display position corresponding to the at least one virtual object, the voice identification element being configured to indicate that the session audio is currently being transmitted.

Exemplarily, the voice identification element is displayed at the preset display position of the first virtual object. The voice identification element is configured to indicate that the first virtual object is transmitting a session audio to the second virtual object in a current virtual social scene.

In addition, another social networking may also be performed, such as a social text interaction. Text content is typed into a dialog box and transmitted, and the dialog box and the text content are displayed in the virtual social scene, to implement the social text interaction in the form of text communication, or
a social video interaction. After the first virtual object is added to the first ground region range, a video acquisition component of each of the first virtual object and the second virtual object within the first ground region range is automatically enabled. The video acquisition component includes a camera, a microphone, and a speaker. The first virtual object and the second virtual object may automatically join a social video interaction through the video acquisition component. After the first virtual object and the second virtual object join the social video interaction, a video display region is displayed at a preset display position corresponding to each of the first virtual object and the second virtual object. A video picture acquired by the video acquisition component corresponding to the first virtual object and a video picture acquired by the video acquisition component corresponding to the second virtual object are displayed in the video display region.

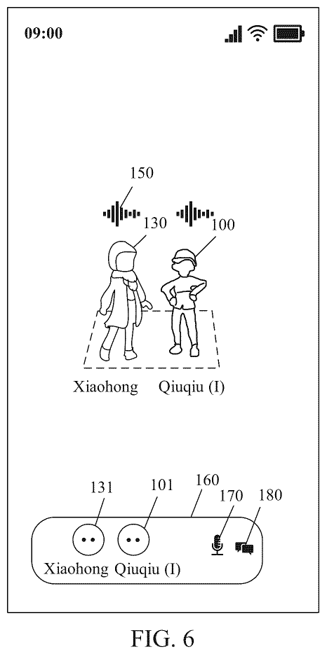

Exemplarily, FIG. 6 is a schematic diagram displaying a social networking animation according to an exemplary embodiment of this application.

A case in which a first virtual object 100 has an identifier name of “Qiuqiu”, a second virtual object 130 has an identifier name of “Xiaohong”, and a virtual social scene is an open space is used as an example. The first virtual object 100 and the second virtual object 130 are both located within a first ground region range.

A prompt box 160 is arranged directly below a screen of a terminal device, which displays a current social networking within the first ground region range, and includes an avatar 101 of a virtual image of the first virtual object 100, an avatar 131 of a virtual image of the second virtual object 130, and identifier names. After expansion from a perspective of the first virtual object 100, a microphone 170 and an identification graphic 180 of a text bubble being displayed on a right side of the prompt box 160 may be seen.

On or off may be selected by clicking/tapping the microphone, and transmission of a text chat message may be selected by clicking/tapping the text bubble.

The identifier name is also displayed below each of the virtual image of the first virtual object 100 and the virtual image of the second virtual object 130. A volume identification graphic 150 is displayed directly above the virtual image, which indicates that the first virtual object 100 and the second virtual object 130 are having a voice chat, i.e., a social voice interaction.

The avatars of all of the virtual objects may be images of any content, and the social voice interaction and the social text interaction may be performed simultaneously or separately. In a social networking, at least two virtual objects may be within the same ground region range, which is not limited in this embodiment.

In some embodiments, when the first virtual object enters the first ground region range, the first virtual object and the second virtual object are successively displayed in a preset arrangement order based on a sequence in which the first virtual object and the second virtual object enter the first ground region range.

The preset arrangement order includes at least one of a left-to-right order, a right-to-left order, a top-to-bottom order, and a bottom-to-top order, which is not limited in the embodiments of this application.

Exemplarily, a virtual object A first enters the first ground region range, then a virtual object B enters the first ground region range, and finally a virtual object C enters the first ground region range. In this case, the virtual object A, the virtual object B, and the virtual object C are successively displayed in the left-to-right order within the first ground region range.

Based on the above, according to the method provided in the embodiments of this application, through a manner in which a target social location is determined by changing a range of the virtual social scene displayed in a terminal screen, so that the virtual object appears at the target social location and interacts with another virtual object, the virtual object does not need to be gradually controlled to move from a starting point to the target social location. Compared with the method required to control a movement direction and a mode of motion of the virtual object strictly based on a movement path in the related art, the method provided in the embodiments of this application has simple operation and no cumbersome operations, which improves efficiency of controlling the virtual object to perform a social networking in the virtual social scene by a user.

According to the method provided in the embodiments of this application, after the user slides the terminal screen to change the display range of the virtual social scene, if an overlap relationship exists between a first identification point in the changed display range and the first ground region range, the social networking is enabled, which improves efficiency of enabling a virtual social networking.

According to the method provided in the embodiments of this application, the overlap relationship between the first identification point and the first ground region range is determined by mapping the first identification point to the virtual social scene. To be specific, only a single identification point needs to be mapped to determine a positional relationship between the single identification point and a ground region, which reduces consumption of computing resources during the mapping.

According to the method provided in the embodiments of this application, the overlap relationship between the first identification point and the first ground region range is determined by mapping the first ground region range to a two-dimensional plane of a second display range. Compared with point-to-surface mapping, surface-to-surface mapping causes the first ground region range mapped to the second display range to be more likely to include the first identification point during single-pass mapping, which improves efficiency during determination of the overlap.

According to the method provided in the embodiments of this application, the first identification point may implement a central point of the display range, and therefore the user can move the first ground region range to the center of the terminal screen by changing the display range, to enable the social networking, which improves efficiency of human-machine interaction during enabling of the virtual social networking.

According to the method provided in the embodiments of this application, after the user changes the display range, if the display range and the first ground region range satisfy the positional relationship requirement, the social networking is enabled after a duration for which the positional relationship is satisfied reaches the preset duration. In other words, the user can change the display range at any time within the preset duration to switch a virtual object that the user wants to interact with, which improves freedom and flexibility of the social networking.

According to the method provided in the embodiments of this application, when the first virtual object and the second virtual object are simultaneously within the ground region range, a voice interaction animation is displayed. In addition, when a virtual object transmits a session audio, a voice identification element is displayed at the display position corresponding to the virtual object, thereby reminding another user that a user corresponding to the virtual object is transmitting the session audio, which improves the efficiency of the human-machine interaction during the social voice interaction.

According to the method provided in the embodiments of this application, when the first virtual object and the second virtual object are simultaneously within the ground region range, the voice interaction animation is enabled by automatically enabling the voice acquisition component, which improves efficiency of performing a voice interaction.

According to the method provided in the embodiments of this application, the display range corresponding to the virtual social scene is changed by using a sliding operation performed on the virtual social scene, which improves convenience of performing a display range adjustment operation.

According to the method provided in the embodiments of this application, the virtual objects are displayed in the current ground region range in an order of joining, so that the user can have a more visual understanding of the order in which the virtual objects join the social networking, which improves the efficiency of the human-machine interaction.

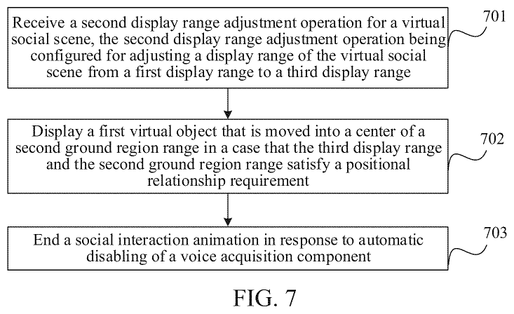

In some embodiments, the virtual object may choose to join the social networking or choose to exit the social networking. FIG. 7 is a flowchart of a first virtual object exiting a current social networking according to an embodiment of this application. As shown in FIG. 7, the following operations are included.

Operation 701: Receive a second display range adjustment operation for a virtual social scene, the second display range adjustment operation being configured for adjusting a display range of the virtual social scene from a first display range to a third display range.

The second display range adjustment operation means that a user performs an operation of sliding a screen of a mobile terminal, so that a change of the display range that can be observed on the screen of the mobile terminal is adjustment from the first display range to another display range, such as the third display range.

The operation of sliding the screen of the mobile terminal by the user refers to clicking/tapping the screen of the mobile terminal by using a finger or a mouse, and performing movement in each direction. The second display range adjustment operation is stopped until the third display range and a second ground region range satisfy a positional relationship requirement.

In some embodiments, when the foregoing mobile terminal is a terminal such as a mobile phone or a tablet computer that may implement a touch screen operation, the finger is selected to slide the screen to adjust the display range, or an accessory that supports the touch screen operation is selected to adjust the display range. When the foregoing mobile terminal is a terminal such as a desktop computer or a notebook computer that cannot implement the touch screen operation, the display range may be adjusted by clicking/tapping and dragging by using the mouse.

The foregoing direction of movement may be any direction, which is not limited in this embodiment.

Operation 702: Display a first virtual object that is moved into a center of the second ground region range when the third display range and the second ground region range satisfy the positional relationship requirement.

The second ground region range does not include another virtual object other than the first virtual object.

After the second display range adjustment operation, the third display range and the second ground region range satisfy the positional relationship requirement. After a duration after release reaches a preset duration, the first virtual object is moved into the second ground region range, leaves a first ground region range, and ends a social networking with a second virtual object.

Operation 703: End a social networking animation in response to automatic disabling of a voice acquisition component.

A prompt box directly below the screen disappears, a microphone and an identification graphic of a text bubble are no longer displayed, and a volume identification graphic is no longer displayed directly above the first virtual object and the second virtual object.

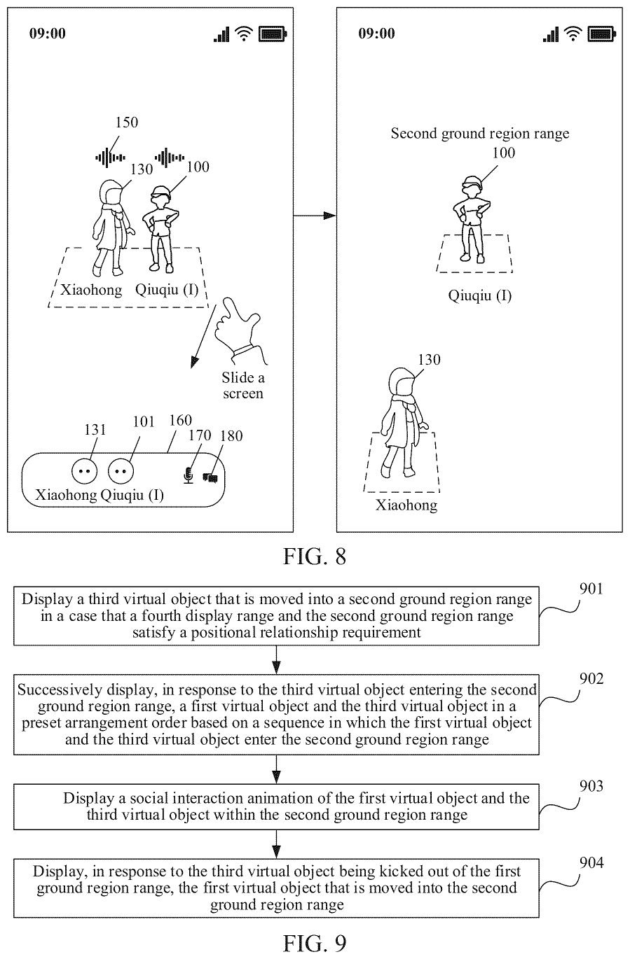

Exemplarily, FIG. 8 is a schematic diagram showing that a first virtual object 100 leaves a first ground region range and is moved to a center of a second ground region range according to an exemplary embodiment of this application.

A case in which a first virtual object 100 has an identifier name of “Qiuqiu”, a second virtual object 130 has an identifier name of “Xiaohong”, and a virtual social scene is an open space is used as an example. A screen is slid to cause a third display range of the first virtual object 100 and the second ground region range to satisfy a positional relationship requirement. After a duration after release reaches a preset duration, the first virtual object 100 that is moved into the second ground region range is displayed.

In this case, the first virtual object 100 is located within the second ground region range, and the second virtual object 130 is still located within the first ground region range.

A prompt box 160 directly below a screen of a terminal device disappears, and a microphone 170 and an identification graphic 180 of a text bubble are no longer displayed. The respective identifier name is also displayed below each of a virtual image of the first virtual object 100 and a virtual image of the second virtual object 130, and a volume identification graphic 150 is no longer displayed directly above the virtual image, which indicates that a social networking between the first virtual object 100 and the second virtual object 130 has ended.

The second ground region range does not include another virtual object other than the first virtual object. The first virtual object does not perform any social networking.

In the foregoing embodiment, the first virtual object is moved into the second ground region range, and no other virtual objects exist within the second ground region range. In some embodiments, any quantity of virtual objects may exist within the second ground region range, which is not limited in this embodiment. Moreover, if another virtual object exists within the second ground region range, the first virtual object automatically joins the social networking with the another virtual object after moving into the second ground region range.

Based on the above, according to the method provided in the embodiments of this application, the second ground region range, i.e., a new target location, is found by adjusting a display range of the first virtual object, so that the first virtual object appears in the second ground region range by sliding the screen and releasing the screen for more than a preset duration. The first virtual object and the second virtual object respectively end a current social networking, so that the virtual objects may leave at any time and can end the social networking without completing a complete route, which improves efficiency of switching the social virtual object and a social status during the social networking.

In some embodiments, a current virtual object may actively join the social networking with the another virtual object, or may passively accept the social networking with the another virtual object. In fact, the current virtual object may also refuse the social networking with the another virtual object, and the another virtual object may also refuse the social networking with the current virtual object. FIG. 9 is a flowchart showing that a third virtual object joins a social networking with a first virtual object and is rejected by the first virtual object according to another embodiment of this application. As shown in FIG. 9, the following operations are included.

Operation 901: Display the third virtual object that is moved into a second ground region range when a fourth display range and the second ground region range satisfy a positional relationship requirement.

In some embodiments, the fourth display range is a range of a terminal in which a virtual social scene where the third virtual object is located is displayed, and the third virtual object is another virtual object other than the first virtual object and a second virtual object in the virtual social scene. A user corresponding to the third virtual object adjusts the fourth display range on a primarily controlled terminal device controlled by the third virtual object, so that the fourth display range and the second ground region range satisfy a positional relationship requirement, i.e., an overlap relationship exists between the fourth display range and the second ground region range.

In some embodiments, both the first virtual object and the third virtual object are within the second ground region range, and the first virtual object and the third virtual object are displayed in an order of entering the second ground region range. In a process of the third virtual object appearing in the second ground region range, the user does not need to manually control a movement direction and a movement path of the third virtual object. The third virtual object is moved from a virtual social scene location corresponding to the fourth display range to the virtual social scene corresponding to the second ground region range determined by adjusting the display range.

An operation of moving the third virtual object into the second ground region range is the same as an operation of moving the first virtual object into the second ground region range. A difference is that different terminal devices have different primarily controlled virtual objects. The third virtual object may be any virtual object different from the first virtual object and the second virtual object in a current virtual social scene. Any quantity of virtual objects may exist in the virtual social scene, which is not limited in this embodiment.

Operation 902: Successively display, in response to the third virtual object entering the second ground region range, the first virtual object and the third virtual object in a preset arrangement order based on a sequence in which the first virtual object and the third virtual object enter the second ground region range.

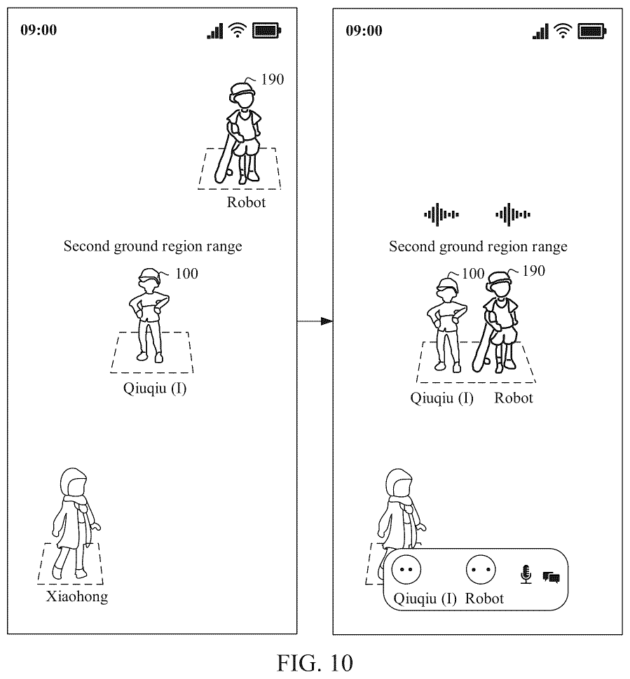

Exemplarily, a case in which a first virtual object has an identifier name of “Qiuqiu”, a second virtual object has an identifier name of “robot”, and a virtual social scene is an open space is used as an example. As shown in FIG. 10,
the first virtual object and the third virtual object are both located within the second ground region range. The first virtual object and the third virtual object are successively arranged from left to right based on a sequence of entering the second ground region range. The first virtual object is displayed on a leftmost side of the second ground region range, and the third virtual object is displayed on a right side of the first virtual object. Respective identifier names are respectively displayed below virtual images corresponding to the first virtual object and the third virtual object.

The first virtual object and the third virtual object are successively displayed in a preset arrangement order. The preset arrangement order may be any order, but is bound to correspond to a sequence in which all of the virtual objects enter the second ground region range, which is not limited in this embodiment. Any quantity of virtual objects may exist within the foregoing second ground region range, but no matter how many virtual objects exist, the virtual objects are displayed in the preset arrangement order based on the sequence in which the virtual objects enter the second ground region range.

Operation 903: Display a social networking animation of the first virtual object and the third virtual object within the second ground region range.

In some embodiments, after the third virtual object enters the second ground region range, a voice acquisition component of each of the first virtual object and the third virtual object within the second ground region range is automatically enabled. The first virtual object and the second virtual object join a social voice interaction, and respective voice identification elements are displayed.

In some embodiments, if the virtual object types text content into a dialog box and transmit the text content, the dialog box and the text content are displayed in the virtual social scene, so that a social text interaction may be performed.

Exemplarily, as shown in FIG. 10, a first virtual object 100 with an identifier name of “Qiuqiu” and a third virtual object 190 with an identifier name of “robot” are used as an example.

A prompt box is arranged directly below a screen of a terminal device, in which a current social networking within the second ground region range is displayed, including an avatar of a virtual image of the first virtual object 100, an avatar of a virtual image of the third virtual object 190, and identifier names. After expansion from a perspective of the first virtual object 100, a microphone and an identification graphic of a text bubble being displayed on a right side of the prompt box may be seen.

The foregoing social networking animation of the first virtual object and the third virtual object within the second ground region range is consistent with the social networking animation of the first virtual object and the second virtual object within the first ground region range. A difference is that the virtual objects are different.

Operation 904: Display, in response to the third virtual object being kicked out of the first ground region range, the first virtual object that is moved into the second ground region range.

In some embodiments, only a first virtual object entering the second ground region range has a permission to kick a subsequent virtual object out of a chat, and no subsequent virtual object has the permission to kick any virtual object out of the chat. In this embodiment of this application, the first virtual object first enters the second ground region range. On a current terminal device, an avatar of the virtual object to be kicked out is clicked/tapped, and an operation of “adding friends” or “kicking out of a chat” may be performed.

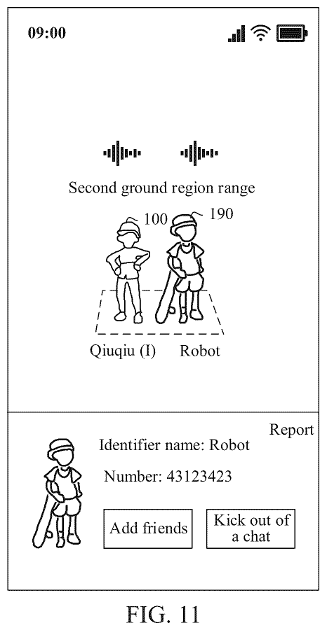

Exemplarily, as shown in FIG. 11, a first virtual object 100 is used as a primarily controlled terminal device. In response to clicking/tapping an avatar of a third virtual object 190, relevant information of the third virtual object 190 is displayed on a screen: a virtual image of the third virtual object 190, an identifier name of “robot”, and an account number “43123423”. From a perspective in which the first virtual object 100 is used as a primarily controlled virtual object, an option button of “adding friends” or “kicking out of a chat” may be chosen to perform a corresponding operation.

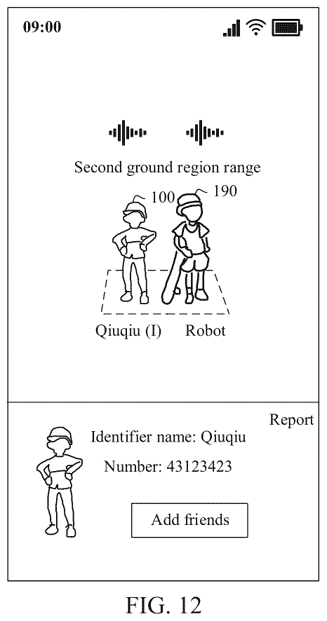

Exemplarily, as shown in FIG. 12, a third virtual object 190 is used as a primarily controlled terminal device. In response to clicking/tapping an avatar of a first virtual object 100, relevant information of the first virtual object 100 is displayed on a screen: a virtual image of the first virtual object 100, an identifier name of “Qiuqiu”, and an account number “3454435634”. From a perspective in which the third virtual object 190 is used as a primarily controlled virtual object, only the option button of “adding friends” may be chosen to perform a corresponding operation.

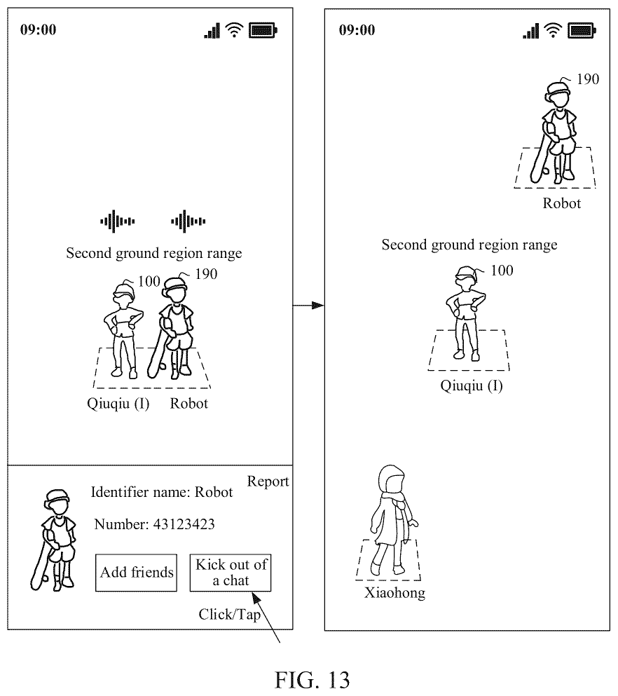

As shown in FIG. 13, a first virtual object 100 is used as a primarily controlled terminal device. In response to an operation of clicking/tapping the button of “kicking out of a chat”, the third virtual object 190 is moved out of the second ground region range. A prompt box directly below a screen of a terminal device disappears, and a microphone and an identification graphic of a text bubble are no longer displayed. The respective identifier name is displayed below each of a virtual image of the first virtual object 100 and a virtual image of the third virtual object 190, and a volume identification graphic is no longer displayed directly above the virtual image, which indicates that a social networking between the first virtual object 100 and the third virtual object 190 ends, and the corresponding social networking animation also ends.

Only two virtual objects exist within the second ground region range. In some embodiments, any quantity of virtual objects may exist within the second ground region range. No matter how many virtual objects exist, the first virtual object may perform the operation of “kicking out of a chat” or “adding friends” on any virtual object that enters the second ground region range later. However, another virtual object that enters the second ground region range after the first virtual object may also perform the operation of “adding friends” on any virtual object, but cannot perform the operation of “kicking out of a chat”, which is not limited in this embodiment. The account number may be a number consisting of any number of digits, which is not limited in this embodiment.

Based on the above, the embodiments of this application provide an operation method in which another virtual object may be “kicked out of a chat” by clicking/tapping the avatar, and restrict that only the virtual object that first enters the current ground region range has the permission, so as to prevent the social networking from being frequently interrupted as a result of a random operation performed by a terminal primarily controlled by another virtual object. A manner of ending the current social networking may be the operation of “kicking out of a chat” or causing the primarily controlled virtual object to leave the current ground region range to automatically end a conversation. The operation is very simple, and efficiency of entering or ending the social networking is also higher.

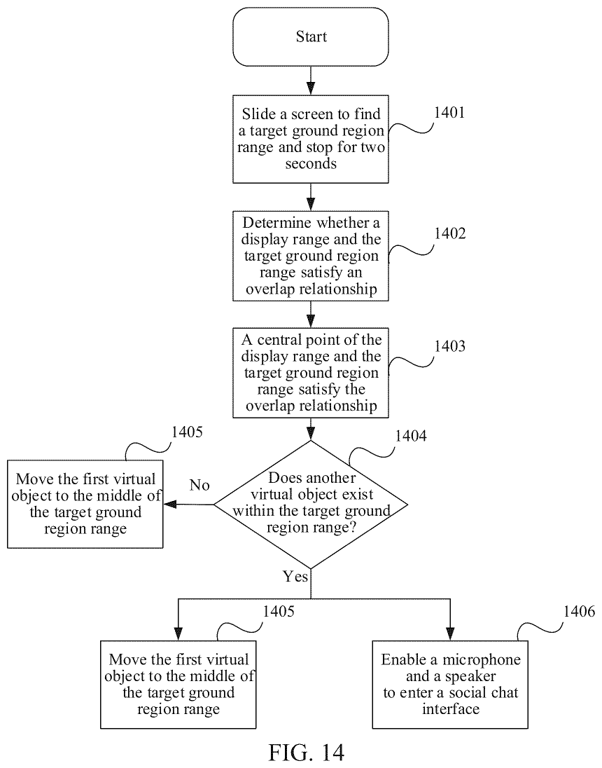

FIG. 14 is an operation flowchart showing that a first virtual object is used as a primarily controlled terminal device according to another exemplary embodiment of this application. As shown in FIG. 14, the method includes the following operations.

Operation 1401: A user stops for two seconds after sliding a screen to find a target ground region.

The first virtual object is used as a primarily controlled virtual object of the user. An operation of sliding the screen is based on a mobile terminal, and is implemented by using a finger. When the screen is slid, a change of a virtual social scene is observed through the screen. The target ground region to which the user wants the first virtual object to move is determined based on the change of the virtual social scene. After the target ground area is found, the user releases for two seconds and stops sliding the screen.

In some embodiments, the operation of sliding the screen may be implemented by using different terminal devices in combination with corresponding accessories. For example, when a desktop computer is used as a terminal device, a change of a display range may be implemented by clicking/tapping and holding and dragging a mouse. The mouse is released for two seconds after the target ground region is found.

The operation of sliding the screen may also be implemented by using the terminal device such as a tablet computer and a laptop computer, which is not limited in this embodiment.

A duration after release of the user is a preset duration, which may be any duration and is not limited in this embodiment.

Operation 1402: Determine whether the display range and the target ground region range satisfy an overlap relationship.

The display range is a range of a scene picture of the virtual social scene displayed on a terminal screen when the user slides the screen.

If the overlap relationship is satisfied, the first virtual object may accurately fall within the target ground region range. If the overlap relationship is not satisfied, the operation of sliding the screen needs to be repeated to cause the first virtual object to accurately fall within the target ground region range.

Operation 1403: A central point of the display range and the target ground region range satisfy the overlap relationship.

Specifically, if the central point of the display range falls within the target ground region range, it indicates that the first virtual object may accurately fall within the target ground region range.

Operation 1404: Determine whether another virtual object exists within the target ground region range.

In some embodiments, a second virtual object is used to refer to the another virtual object herein.

In some embodiments, any quantity of other virtual objects may exist within the target ground region range, such as the second virtual object and a third virtual object, which is not limited in this embodiment.

Operation 1405: Move the first virtual object to the middle of the target ground region range if no another virtual object exists within the target ground region range.

After the first virtual object is moved to the middle of the target ground region range, the target ground region range is automatically displayed in a center of the screen, and the first virtual object is also displayed in the center of the screen.

Operation 1406: Move the first virtual object to the middle of the target ground region range and automatically enable a microphone and a speaker if another virtual object exists within the target ground region range, so as to enter a social chat interface.

In some embodiments, the second virtual object exists in the target ground region range. After the first virtual object is moved to the target ground region range, voice acquisition components such as the microphone and the speaker of each of the first virtual object and the second virtual object are automatically enabled. The first virtual object and the second virtual object immediately enter the social chat interface, i.e., perform a social networking.

In some embodiments, the social networking includes, but is not limited to a social voice interaction and a social text interaction. A plurality of virtual objects may exist in the target ground region range, which is not limited in this embodiment. If more than one virtual object already exists within the target ground region range, such as the second virtual object and the third virtual object, the social chat interface already exists within the target ground region range. The first virtual object automatically joins the existing social chat interface after moving to the target ground region range, and the voice acquisition components such as the microphone and the speaker of the first virtual object are automatically enabled.

In some embodiments, the user joins the social networking of the virtual social scene by using the first virtual object as a primarily controlled image, may perform the social voice interaction through the microphone, or may enter texts into the text box for the social text interaction. Different social networkings may be performed simultaneously or separately, which is not limited in this embodiment.

Based on the above, according to the method provided in the embodiments of this application, a target location where the virtual object corresponding to the user is expected to reach is searched and changed through the operation of sliding the screen of the terminal device by the user, and it is determined whether the another virtual object exists at the target location, to implement position movement of the first virtual object and automatically join the social networking, which improves the efficiency of the social networking of the virtual object corresponding to the user in the virtual scene, and does not cause the virtual object to join another social networking due to an operation error during the movement.

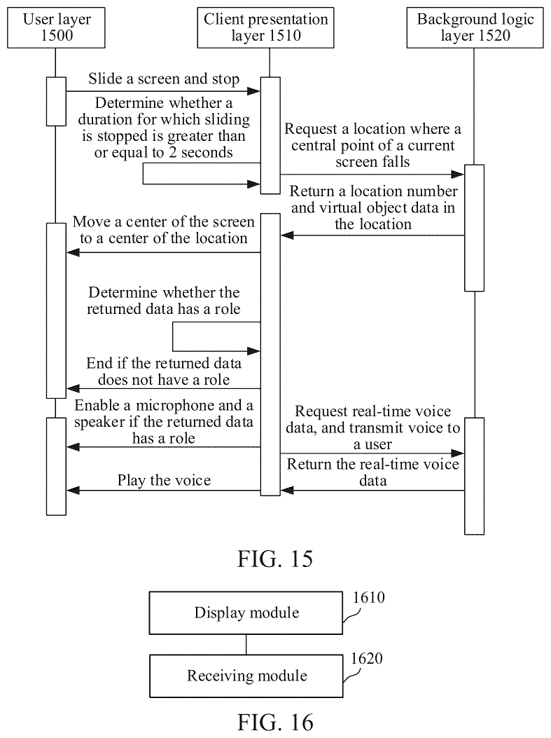

FIG. 15 is a specific timing diagram according to an exemplary embodiment of this application, which is configured to represent a specific timing relationship among a user layer, a client presentation layer, and a background logic layer. As shown in FIG. 15, the user layer 1500 represents a user that primarily controls a first virtual object, and may perform an operation such as sliding and voice on a primarily controlled terminal device.

The client presentation layer 1510 represents the primarily controlled terminal device, and may transmit information to the user layer 1500 through a screen, and receive and respond to the operation of the user layer 1500.

The background logic layer 1520 represents a background of the primarily controlled terminal device, and is configured to process and determine various data generated during the operation of the user layer 1500 and the client presentation layer 1510.

The user layer 1500 stops after sliding the screen. The client presentation layer 1510 immediately determines whether a duration after the user stops the sliding is greater than or equal to two seconds. If the duration is less than two seconds, the user continues to slide the screen, and continues to adjust a display range. If the duration is greater than or equal to two seconds, the first virtual object primarily controlled by the user is moved to a current target location.

After the first virtual object is moved to the current target location, the client presentation layer 1510 requests the background logic layer 1520 for information about the current target location at which the first virtual object falls, including but not limited to a location number, data of the virtual object at the location, and the like.

The client presentation layer 1510 moves the center of the screen to the current target location where the first virtual object is located, namely, the current target location where the first virtual object and the first virtual object are located is displayed in the center of the screen.

The client presentation layer 1510 determines, based on the data returned by the background logic layer 1520, whether another virtual object exists at the current target location. If no another virtual object exists, only the operation of moving the first virtual object to the current target location is implemented and presented to the user layer 1500 through the screen. If the another virtual object exists, the client presentation layer 1510 automatically enables the microphones and the speakers of the first virtual object and the another virtual object, and the user layer 1500 performs a social networking in real time through the microphone and the speaker.

Specifically, if the user corresponding to any virtual object at the current target location starts a voice chat, the client presentation layer 1510 immediately requests real-time voice data from the background logic layer 1520, and transmits voice of another user. The background logic layer 1520 returns the real-time voice data to the client presentation layer 1510, and the client presentation layer 1510 plays voice to the user layer 1500 to implement the social voice interaction between the first virtual object and the another virtual object.

Based on the above, user operations are received, responded, determined, and processed by three different levels including the user layer, the client presentation layer, and the background logic layer, so that the user may control the virtual object to implement the social networking, which is faster, coherent, and more efficient in data processing. Finally, redundant and cumbersome operations are avoided, and an experience effect of the user using the virtual object to perform the social networking is also improved.

The social networking method provided in this application is not only applicable to a scene including the virtual object, but also can be used in a social scene that does not include the virtual object. Exemplarily, the foregoing virtual object may be replaced with an avatar of a user, a user nickname, or the like. When an avatar of the primary control user is located in a first position of the social scene, an avatar of another user further exists in the current social scene, and the avatar of the another user is located in a second position of the social scene.

In response to an operation of adjusting a display range of the social scene, the second position where the avatar of the another user is located overlaps with the display range. The display range is a middle region of the screen. The avatar of the primary control user moved to the second position is displayed, and a social networking animation of the avatar of the primary control user and the avatar of the another user in the second position is displayed.

It may be learned that according to the social networking method provided in the embodiments of this application, the process of triggering to enable the social networking does not need to be driven by an engine on the technical side, and technical implementation costs are low. Compared with the solution in which a drive engine is needed to render the movement process of the virtual object in the related art, consumption of computing resources is reduced.

FIG. 16 is a structural block diagram of a social networking apparatus according to an exemplary embodiment of this application. As shown in FIG. 16, the apparatus includes:
a display module 1610, configured to display, when a scene picture corresponding to a virtual social scene is displayed in a first display range, a first virtual object in the virtual social scene, the first virtual object being a virtual object primarily controlled by a current terminal, the virtual social scene further including a second virtual object, the second virtual object being located within a first ground region range divided in the virtual social scene; and
a receiving module 1620, configured to receive a first display range adjustment operation for the virtual social scene, the first display range adjustment operation being configured for adjusting a display range of the virtual social scene from the first display range to a second display range;
the display module 1610 being further configured to display the first virtual object that is moved into the first ground region range when the second display range and the first ground region range satisfy a positional relationship requirement; and
the display module 1610 being further configured to display a social networking animation of the first virtual object and the second virtual object within the first ground region range.

In some embodiments, the display module 1610 is further configured to display the first virtual object that is moved into the first ground region range when an overlap relationship exists between a first identification point in the second display range and the first ground region range.

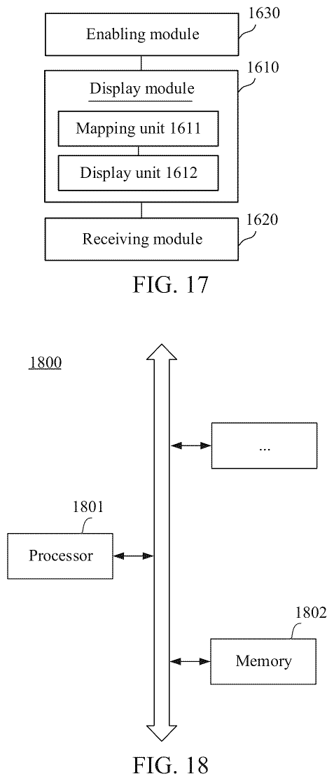

In some embodiments, as shown in FIG. 17, the display module 1610 includes:
a mapping unit 1611, configured to map the first identification point in the second display range to the virtual social scene to obtain a first mapping position; and
a display unit 1612, configured to display the first virtual object that is moved into the first ground region range when the first mapping position is located within the first ground region range;
or
the display module 1610 includes:
a mapping unit 1611, configured to map the first ground region range to a two-dimensional plane of the second display range, to obtain a second mapping region; and
a display unit 1612, configured to display the first virtual object that is moved into the first ground region range when the second mapping region includes the first identification point in the second display range.

In some embodiments, the display module 1610 is further configured to display the first virtual object that is moved into the first ground region range when an overlap relationship exists between a central point in the second display range and the first ground region range.

In some embodiments, the display module 1610 is further configured to display the first virtual object that is moved into the first ground region range when the second display range and the first ground region range satisfy the positional relationship requirement and a duration required for satisfying the positional relationship requirement reaches a preset duration requirement.

In some embodiments, the display module 1610 is further configured to display a voice interaction animation of the first virtual object and the second virtual object within the first ground region range,
when at least one of the first virtual object and the second virtual object transmits a session audio, a voice identification element being displayed at a preset display position corresponding to the at least one virtual object, the voice identification element being configured to indicate that the session audio is currently being transmitted.

In some embodiments, the apparatus further includes
an enabling module 1630, configured to automatically enable a voice acquisition component.

The display module 1610 is further configured to display the voice interaction animation of the first virtual object and the second virtual object within the first ground region range when the voice acquisition component is enabled.

In some embodiments, the receiving module 1620 is further configured to receive a sliding operation performed on the virtual social scene, a sliding direction of the sliding operation corresponding to a changing direction from the first display range to the second display range.

In some embodiments, the display module 1610 is further configured to successively display, when the first virtual object enters the first ground region range, the first virtual object and the second virtual object in a preset arrangement order based on a sequence in which the first virtual object and the second virtual object enter the first ground region range.

In some embodiments, the receiving module 1620 is further configured to receive a second display range adjustment operation for the virtual social scene, the second display range adjustment operation being configured for adjusting a display range of the virtual social scene from the first display range to a third display range.

The display module 1610 is further configured to display, when the third display range and a second ground region range satisfy the positional relationship requirement, the first virtual object that is moved to a center of the second ground region range, the second ground region range not including another virtual object other than the first virtual object.

Based on the above, according to the apparatus provided in this application, through a manner in which a target social location is determined by changing a range of the virtual social scene displayed in a terminal screen, so that the virtual object appears at the target social location and interacts with another virtual object, the virtual object does not need to be gradually controlled to move from a starting point to the target social location, which simplifies the process of enabling a virtual interaction. Compared with the method required to control a movement direction and a mode of motion of the virtual object strictly based on a movement path in the related art, the method provided in the embodiments of this application has simple operation and no cumbersome operations, which improves efficiency of controlling the virtual object to perform a social networking in the virtual social scene.

FIG. 18 is a structural block diagram of a computer device 1800 according to an exemplary embodiment of this application. The computer device 1800 may be a smartphone, a tablet computer, an MP3 player, an MP4 player, a notebook computer, or a desktop computer. The computer device 1800 may further be referred to as another name such as user equipment, a portable terminal, a laptop terminal, or a desktop terminal.

Generally, the computer device 1800 includes a processor 1801 and a memory 1802.

The processor 1801 may include one or more processing cores, such as a 4-core processor and an 8-core processor. The processor 1801 may be implemented in at least one hardware form of a digital signal processor (DSP), a field-programmable gate array (FPGA), and a programmable logic array (PLA). The processor 1801 may also include a main processor and a coprocessor. The main processor is a processor configured to process data in an awake state, and is also referred to as a central processing unit (CPU). The coprocessor is a low-power processor configured to process data in a standby mode. In some embodiments, the processor 1801 may be integrated with a graphics processing unit (GPU). The GPU is configured to render and draw content that needs to be displayed on a display screen. In some embodiments, the processor 1801 may further include an AI processor. The AI processor is configured to process computing operations related to machine learning.

The memory 1802 may include one or more computer-readable storage media. The computer-readable storage medium may be non-transient. The memory 1802 may further include a high-speed random access memory and a nonvolatile memory, for example, one or more disk storage devices or flash storage devices. In some embodiments, the non-transitory computer-readable storage medium in the memory 1802 is configured to store at least one instruction. The at least one instruction is configured for being executed by the processor 1801 to implement the social networking method provided in the method embodiment of this application.

In some embodiments, the computer device 1800 also includes other components. A person skilled in the art may understand that the structure shown in FIG. 18 does not constitute a limitation on the terminal 1800. The terminal may include more or fewer components than those shown in the figure, or some merged components, or different component arrangements.

In some embodiments, the computer-readable storage medium may include a read-only memory (ROM), a random access memory (RAM), a solid state drive (SSD), an optical disc, or the like. The RAM may include a resistance RAM (ReRAM) and a dynamic RAM (DRAM). The serial numbers of the foregoing embodiments of this application are merely for description, and do not represent the preference of the embodiments.

An embodiment of this application further provides a computer device, including a processor and a memory, the memory having at least one instruction, at least one program, a code set, or an instruction set stored therein, the at least one instruction, the at least one program, the code set, or the instruction set being loaded and executed by the processor to implement the social networking method according to any one of the foregoing embodiments of this application.

An embodiment of this application further provides a computer-readable storage medium, the computer-readable storage medium having at least one instruction, at least one program, a code set, or an instruction set stored therein, the at least one instruction, the at least one program, the code set, or the instruction set being loaded and executed by a processor to implement the social networking method according to any one of the foregoing embodiments of this application.

An embodiment of this application further provides a computer program product or a computer program, the computer program product or the computer program including a computer instruction, the computer instruction being stored in a computer-readable storage medium. The processor of the computer device reads the computer instruction from the computer-readable storage medium. The processor executes the computer instruction, causing the computer device to perform the social networking method according to any one of the foregoing embodiments.

In sum, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. A person of ordinary skill in the art may understand that all or part of the operations of implementing the foregoing embodiments may be implemented by hardware, or may be implemented by a program instructing related hardware. The program may be stored in a computer-readable storage medium. The storage medium mentioned may be a read-only memory, a magnetic disk or an optical disc.

What is claimed is:

1. A social networking method performed by a computer device, the method comprising:
displaying a scene picture corresponding to a first display range of a virtual social scene, the virtual social scene including a first virtual object and a second virtual object, the second virtual object being located within a first region in the virtual social scene;
receiving a first display range adjustment operation for adjusting a display range of the virtual social scene from the first display range to a second display range;
when the second display range and the first ground region range satisfy a positional relationship requirement, displaying an animation of the first virtual object moving into the first region; and
displaying a social networking animation of the first virtual object and the second virtual object within the first region.

2. The method according to claim 1, wherein the displaying an animation of the first virtual object moving into the first region comprises:
displaying an animation of the first virtual object moving into the first region when an overlap relationship exists between a first identification point in the second display range and the first region.

3. The method according to claim 1, wherein the displaying an animation of the first virtual object moving into the first region comprises:
displaying an animation of the first virtual object moving into the first region when the second display range and the first region satisfy the positional relationship requirement for at least a preset duration.

4. The method according to claim 1, wherein the displaying a social networking animation of the first virtual object and the second virtual object within the first region comprises:
displaying a voice interaction animation of the first virtual object and the second virtual object within the first region, the voice interaction animation including a voice identification element indicating that at least one of the first virtual object and the second virtual object transmits a session audio.

5. The method according to claim 1, wherein the receiving a first display range adjustment operation comprises:
receiving a sliding operation performed on the virtual social scene, a sliding direction of the sliding operation corresponding to a changing direction from the first display range to the second display range.

6. The method according to claim 1, further comprising:
when the first virtual object enters the first region, displaying the first virtual object and the second virtual object in a preset arrangement order based on a sequence in which the first virtual object and the second virtual object enter the first region.

7. The method according to claim 1, further comprising:
receiving a second display range adjustment operation for adjusting a display range of the virtual social scene from the first display range to a third display range; and
when the third display range and a second region satisfy the positional relationship requirement, displaying an animation of the first virtual object that moving to a center of the second region, the second region only comprising the first virtual object.

8. The method according to claim 1, wherein the displaying an animation of the first virtual object moving into the first region comprises:
displaying an animation of the first virtual object moving into the first region in response to a selection operation performed on the second virtual object within the first region.

9. A computer device, comprising a processor and a memory, the memory having at least one program stored therein, the at least one program being loaded and executed by the processor and causing the computer device to implement a social networking method including:
displaying a scene picture corresponding to a first display range of a virtual social scene, the virtual social scene including a first virtual object and a second virtual object, the second virtual object being located within a first region in the virtual social scene;
receiving a first display range adjustment operation for adjusting a display range of the virtual social scene from the first display range to a second display range;
when the second display range and the first ground region range satisfy a positional relationship requirement, displaying an animation of the first virtual object moving into the first region; and
displaying a social networking animation of the first virtual object and the second virtual object within the first region.

10. The computer device according to claim 9, wherein the displaying an animation of the first virtual object moving into the first region comprises:
displaying an animation of the first virtual object moving into the first region when an overlap relationship exists between a first identification point in the second display range and the first region.

11. The computer device according to claim 9, wherein the displaying an animation of the first virtual object moving into the first region comprises:
displaying an animation of the first virtual object moving into the first region when the second display range and the first region satisfy the positional relationship requirement for at least a preset duration.

12. The computer device according to claim 9, wherein the displaying a social networking animation of the first virtual object and the second virtual object within the first region comprises:
displaying a voice interaction animation of the first virtual object and the second virtual object within the first region, the voice interaction animation including a voice identification element indicating that at least one of the first virtual object and the second virtual object transmits a session audio.

13. The computer device according to claim 9, wherein the receiving a first display range adjustment operation comprises:
receiving a sliding operation performed on the virtual social scene, a sliding direction of the sliding operation corresponding to a changing direction from the first display range to the second display range.

14. The computer device according to claim 9, wherein the method further comprises:
when the first virtual object enters the first region, displaying the first virtual object and the second virtual object in a preset arrangement order based on a sequence in which the first virtual object and the second virtual object enter the first region.

15. The computer device according to claim 9, wherein the method further comprises:
receiving a second display range adjustment operation for adjusting a display range of the virtual social scene from the first display range to a third display range; and
when the third display range and a second region satisfy the positional relationship requirement, displaying an animation of the first virtual object that moving to a center of the second region, the second region only comprising the first virtual object.

16. The computer device according to claim 9, wherein the displaying an animation of the first virtual object moving into the first region comprises:
displaying an animation of the first virtual object moving into the first region in response to a selection operation performed on the second virtual object within the first region.

17. A non-transitory computer-readable storage medium storing at least one program, the at least one program being loaded and executed by a processor of a computer device and causing the computer device to implement a social networking method including:
displaying a scene picture corresponding to a first display range of a virtual social scene, the virtual social scene including a first virtual object and a second virtual object, the second virtual object being located within a first region in the virtual social scene;
receiving a first display range adjustment operation for adjusting a display range of the virtual social scene from the first display range to a second display range;
when the second display range and the first ground region range satisfy a positional relationship requirement, displaying an animation of the first virtual object moving into the first region; and
displaying a social networking animation of the first virtual object and the second virtual object within the first region.

18. The non-transitory computer-readable storage medium according to claim 17, wherein the displaying an animation of the first virtual object moving into the first region comprises:
displaying an animation of the first virtual object moving into the first region when an overlap relationship exists between a first identification point in the second display range and the first region.

19. The non-transitory computer-readable storage medium according to claim 17, wherein the displaying an animation of the first virtual object moving into the first region comprises:
displaying an animation of the first virtual object moving into the first region when the second display range and the first region satisfy the positional relationship requirement for at least a preset duration.

20. The non-transitory computer-readable storage medium according to claim 17, wherein the displaying a social networking animation of the first virtual object and the second virtual object within the first region comprises:
displaying a voice interaction animation of the first virtual object and the second virtual object within the first region, the voice interaction animation including a voice identification element indicating that at least one of the first virtual object and the second virtual object transmits a session audio.
